(19) United States
(12) Patent Application Publication
(10) Pub. No.: US 2005/0074110 A1
(43) Pub. Date: Apr. 7, 2005

(54) Remote local number portability switchover

(76) Inventor: Charles S. Moreman, Grayson, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/677,805

(22) Filed: Oct. 2, 2003

(51) Int. Cl. H04M 3/42

(52) U.S. Cl. 379/212.01

(57) ABSTRACT

Systems and methods are disclosed for an embedded media terminal adapter (EMTA) that remotely switches telephony services from a telephone service provider to a telephony/cable service provider, which transmits telephony services via a coaxial cable network. The EMTA further enables local number portability (LNP) with very limited disruption to service. Switches that are responsive to command signals over the coaxial cable network are included in the EMTA. Upon release of service from the telephone service provider, the telephony/cable service provider transmits a command signal via the coaxial cable network to the EMTA, thereby remotely activating the switches. Subsequently, the EMTA receives telephony services from the telephony/cable service provider.

### FIELD OF THE INVENTION

This invention relates in general to telephony systems over broadband coaxial cable, and more particularly, to the field of enabling remote local number portability in the telephony system.

### DESCRIPTION OF THE RELATED ART

Broadband communications systems, such as satellite and cable television systems, are now capable of providing many services in addition to broadcast audio/video signals over their existing systems. Some advanced services in a broadband communications system along with providing conventional cable television signals are telephony services, such as high-speed data and telephone. To support these services, cable modems are used in the subscriber's premises and have typically been coupled to coaxial cable in a communications network (CN). U.S. Pat. No. 6,161,011 to Loveless, the disclosure and teachings of which are incorporated herein by reference, shows an example of a hybrid fiber/coaxial (HFC) communications network that could be used to implement the present invention.

FIG. 1 illustrates an example of one customer that receives telephony services from a conventional telephone network (TN) 110 via a terminal network interface (TNI) 115 in a known manner. The TNI 115 acts as the central point for receiving and distributing the telephone signals in a wiring network that is routed throughout the premises. Typically, the wiring network is run through the home and terminated at telephone jacks (not shown). A twisted pair cable then attaches a telephone 120, 125 to a jack to complete the path.

More recently, a cable provider can also provide telephony signals over a communications network (CN) 210. FIG. 2 illustrates an example of one customer that receives telephone signals from a telephony/cable provider via a communication medium, such as coaxial or fiber cable 215, to an embedded media terminal adapter (EMTA) 220. It will be appreciated that the CN 210 may also carry conventional cable signals, such as audio/video signals, along with the telephony signals. The EMTA 220 receives the telephony signals from the CN 210 and routes them throughout the wired premises. The EMTA 220 may also provide dual line telephony services with several telephones connected to each line. The EMTA 220 may also provide high speed data service or other services.

When a customer switches from a conventional telephone provider to a telephony/cable provider, the customer receives the telephony signals from a separate network (i.e., from the telephone network (TN) 110 to the communications network (CN) 210). Accordingly, a conventional telephone provider discontinues service with the customer by first updating a computer data record in a telephone system database. Once finished, the service is discontinued. At the time that the service is discontinued the customer's telephone number can be re-allocated from the conventional telephone provider to the telephony/cable service provider.

Previously, simultaneously or subsequently, a telephony/cable provider installs an EMTA 220, in the customer's premises. Once the service is activated with the telephony/cable provider, the EMTA 200 then receives telephony signals from the CN 210. This service provided by the telephony/cable provider cannot use the customer's original telephone number until this telephone number is transferred from the conventional telephone provider to the telephony/cable provider. In order to provide service prior to the transfer of the phone number the telephony/cable provider typically uses a temporary phone number to the customer.

The transition period between switching telephone providers from a telephone network to a communications network has posed problems, however. One problem is the potential period of time of having no service at the telephones connected to the conventional telephony provider while the service is changed from one network to another. Additionally, a customer generally wishes to retain their original phone number despite the decision to change providers and does not want to use a temporary phone number during the transition. This is known in the field as local number portability (LNP), which is a feature that allows a telephone customer to retain their current telephone number while changing from one provider to another. Typically, this is accomplished by having the current telephone provider provide notification to the new telephony/cable provider when the customer's telephone number is available (i.e., once they have discontinued service and released the phone number from their computer system). Once the notice is received, which may take anywhere from 1 to 10 days, the new telephony/cable provider visits the home and physically disconnects the wired network in the house from the TN 115 and connects the telephones 120, 125 to the CN 210 via the EMTA 220. At this point, the new telephony/cable provider enables the subscriber line(s) while retaining the previous telephone number. It will be appreciated, however, that scheduling a visit from the new telephony/cable provider may also take time, thereby leaving the customer without telephone service during the transition period, which is unacceptable.

Thus, there exists a need for a remote LNP switchover that allows a customer to retain their previous telephone number along with a very limited disconnect in service.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 illustrates an example of one customer that receives telephony services from a conventional telephone network (TN) via a terminal network interface (TNI) in a known manner.

FIG. 2 illustrates an example of one customer that receives telephone signals from a telephony/cable provider via a communication medium, such as coaxial or fiber cable, to an embedded media terminal adapter (EMTA).

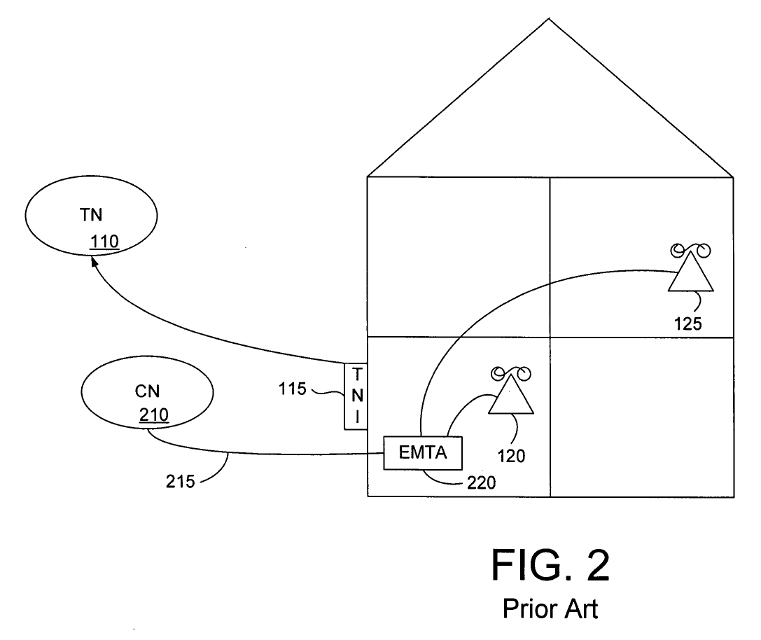

FIG. 3 is an illustration of a conventional EMTA where a telephony/cable provider provides telephone signals to connected telephones via a communications network.

FIG. 4 illustrates an EMTA that remotely switches a customer over to a telephony/cable provider while also enabling LNP in accordance with the present invention.

FIG. 5 illustrates a table providing example command codes that relate to particular messages that are transmitted by the telephony/cable provider remotely enabling the EMTA.

### DETAILED DESCRIPTION OF THE PREFERRED EMBODIMENT

Preferred embodiments of the invention can be understood in the context of a broadband communications system. Note, however, that the invention may be embodied in many different forms and should not be construed as limited to the embodiments set forth herein. All examples given herein, therefore, are intended to be non-limiting and are provided in order to help clarify the description of the invention.

The present invention is directed towards an embedded media terminal adapter (EMTA) including remote local number portability (LNP) switchover capability. The EMTA is coupled to a communications network and receives telephony signals via coaxial cable. Importantly, the present invention enables a customer to retain their existing telephone number during a change in telephony providers having different networks with minimal disruption to their telephone service. It will be appreciated that a telephony/cable service provider provides conventional audio/video signals to the customer along with telephony services, such as high-speed data and telephone signals.

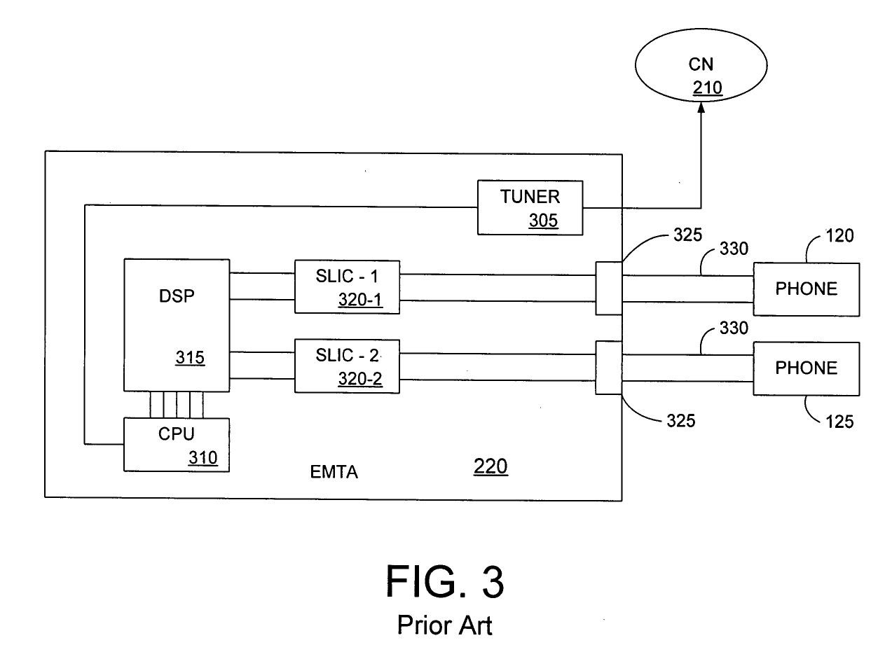

FIG. 3 is an illustration of a conventional EMTA 220 where a telephony/cable provider provides telephone signals to connected telephones via a communications network 210. A tuner 305 tunes to a desired frequency in a range that accepts and routes the telephone services. A central processing unit (CPU) 310 receives the telephone services and processes the signals. Subsequently, the CPU 310 provides the processed signals to a digital signal processor (DSP) 315. Depending on whether the signals are intended for one telephone number or another, the DSP 315 provides the signals to an appropriate subscriber line interface controller (SLIC) 320-1, 320-2 in a known manner. It will be appreciated that two SLICs 320-1, 320-2 are shown implying that the customer has enabled two separate telephone lines; it will be appreciated, however, that there may be more or fewer separate number lines. Connectors 325 are then coupled to the telephones 120, 125 via a communication medium 330, such as twisted pair cable.

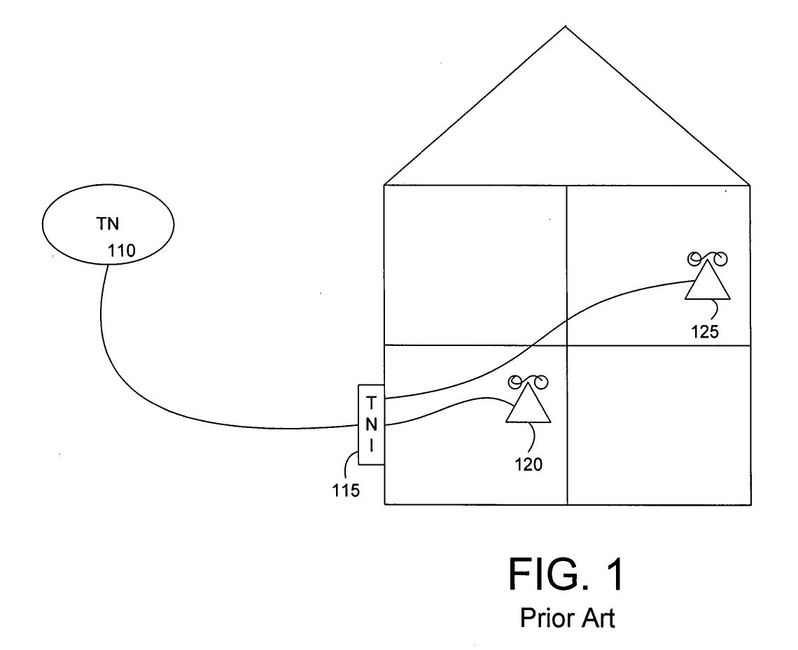

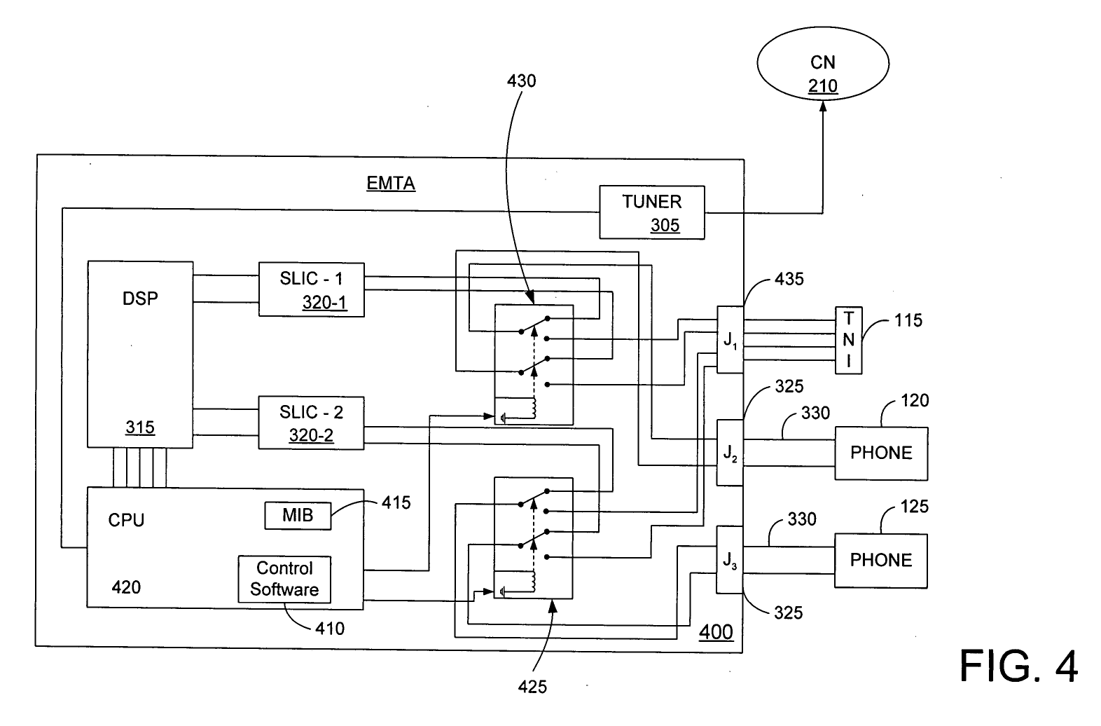

FIG. 4 illustrates an EMTA 400 that remotely switches a customer over to a telephony/cable provider while also enabling LNP in accordance with the present invention. As shown, control software 410 and a management information base (MIB) 415 are included in a CPU 420. Additionally, switches 425, 430 are included in the EMTA 400 that are responsive to the control software 410 and enable the remote switchover. The telephony/cable provider preferably installs the EMTA 400 at the customer's premises prior to the switching of the existing telephone service to the telephony/cable provider. A TNI jack 435 connects the EMTA 400 into the TNI 115, which initially remains connected to the TN 110 (FIG. 1), and the phones 120, 125 are connected to CN jacks 325. Initially, the switches 425, 430 are in the position that allows signals from the TN 110 directed to the CN jacks 325. Therefore, the customer continues to receive telephony signals from the TN 110 until the telephone service provider discontinues the service and disables the phone lines. The alternative position for the switches 425, 430 is to route the telephone signals from the CN 210 to the CNjacks 325 subsequent to the release of the telephone provider.

The EMTA 400 is configured with an address so that it can receive commands to change the values associated with MIB 415. Also the EMTA 400 can receive and respond to commands that report status of the values associated with the MIB 415. The telephony/cable provider uses the EMTA address to send and receive messages using, for example, simple network management protocol (SNMP). A computer located at the telephony/cable provider's headend facility includes a database of the addresses, which are used to transmit and receive the messages, thereby controlling the EMTAs in the system.

When the telephone provider discontinues the customer's service, the telephone company notifies the telephony/cable provider that they have relinquished the previous telephone number(s). The telephony/cable provider immediately sends the EMTA 400 a message using its particular address. Accordingly, a message may include a particular code that is received and processed by the control software 410, which is preferably stored in nonvolatile memory. In this manner, the telephony/cable provider controls the switches 425, 430 in the EMTA 400 to now receive telephone signals from the CN 210 without having to physically revisit the device 400.

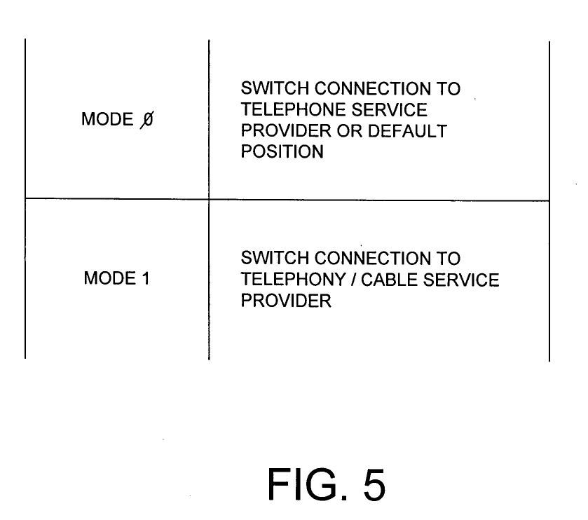

FIG. 5 illustrates a table providing example command codes that relate to particular messages that are transmitted by the telephony/cable provider remotely enabling the EMTA 400. Mode 0 may be a default position of the EMTA 400, which represents that the physical wiring is connected to the previous telephone network via the TNI 110, thereby allowing the EMTA 400 to continue to receive and transmit signals using the previous telephone network. Mode 1 may represent a command that switches the wiring to the new telephony/cable provider, thereby no longer receiving and transmitting signals using the previous telephone network. Accordingly, when the EMTA 400 is originally installed, the default mode for the control software 410 may be mode 0. When the telephony/cable provider receives the notice that the customer's telephone number has been released, a signal that is indicative of mode I is provided via the physical address to the EMTA 400. Once the signal is received, the control software 410 sends a command (e.g., either a high or a low signal) to the switches 425, 430. The switches 425, 430, which were in the default mode 0 position that connects them to the TN 110, are repositioned to receive and transmit signals from the CN 210. The telephony signals received from the CN 210 are subsequently provided to the appropriate telephone via the home wiring. Since the switches 425, 430 are in place to route all signals to and from the CN 210, the physical disconnect between the TNI 115 and the TN 110 does not necessarily have to take place.

Accordingly, systems and methods have been provided that enables a new telephony/cable provider, which typically utilizes different wiring than conventional telephone service providers, a means to offer the new customer their previous telephone number along with a very limited disruption in service. It will be appreciated that further embodiments are envisioned that implement the invention, for example, using all software or adding modes for additional features and services.

1. A terminal, comprising:
remote-switching means for transferring telephony services,
wherein the remote-switching means allows the transference of telephony signals from a first wiring system of a first telephony provider to a second wiring system of a second telephony provider

2. The terminal of claim 1, wherein the remote-switching means allows the transference of wiring to provide local number portability (LNP).

3. The terminal of claim 1, wherein the remote-switching means is responsive to a command signal transmitted by the second telephony provider.

4. The terminal of claim 1, the remote-switching means comprising:
control software for receiving a command signal from the second telephony provider and for providing a command message; and
at least one switch connected between the first and the second wiring systems, the at least one switch responsive to the command message.

5. The terminal of claim 1, wherein the terminal includes an identifiable address, and wherein the second telephony provider transmits a command signal to the terminal using the identifiable address.

6. The terminal of claim 1, further comprising:
a central processing unit (CPU), comprising:
a management information base for storing a terminal address; and
control software for receiving a command signal from the second telephony provider and for providing a command message indicating the transference of signals.

7. The terminal of claim 1, further comprising at least one subscriber line interface controller for receiving and providing the telephony signals to a telephony device.

8. The terminal of claim 1, wherein the second wiring system is a coaxial cable system.
